(19) United States
(12) Patent Application Publication
(10) Pub. No.: US 2004/0250844 A1
(43) Pub. Date: Dec. 16, 2004

(54) Ultrasonic cleaner

(75) Inventor: Michio Kumazaki, Kanagawa (JP)

Correspondence Address: LORUSSO & LOUD, 3137 Mt. Vernon Avenue, Alexandria, VA, 22305, US

(73) Assignee: KUMAZAKI AIM CORPORATION

(21) Appl. No.: 10/698,473

(22) Filed: Nov. 3, 2003

(30) Foreign Application Priority Data
Jun. 16, 2003 (JP) JP2003-170926

(51) Int. Cl. B08B 3/00

(52) U.S. Cl. 134/201; 134/1

(57) ABSTRACT

An ultrasonic cleaner includes a body section; a vibration generator mounted in the body section and having a vibration-transmitting portion formed at its front end for transmitting vibration to an object to be cleaned; and a cleaning-medium feed section for feeding a cleaning medium to the object to be cleaned. The vibration-transmitting portion is pressed against an object to be cleaned to thereby transmit vibration to the object to be cleaned, and a cleaning medium is fed to the object to be cleaned. Thus, vibration causes adhering dirt to be eluted into the cleaning medium from the object to be cleaned, thereby removing dirt from the object.

### BACKGROUND OF THE INVENTION

1. Field of the Invention

The present invention relates to an ultrasonic cleaner.

2. Description of the Related Art

Conventionally, in order to clean clothing, or an object to be cleaned, through utilization of ultrasonic vibration, an ultrasonic cleaning apparatus has been provided. The ultrasonic cleaning apparatus functions such that ultrasonic vibration generated by a vibrator formed of a piezoelectric element is transmitted to clothing via a horn to thereby remove adhering dirt from clothing by means of vibration.

However, the conventional ultrasonic cleaning apparatus requires prior immersion of clothing in a cleaning liquid so as to apply the horn to clothing impregnated with the cleaning liquid, and thus involves troublesome work in cleaning clothing.

In application to cleaning of objects other than clothing, the ultrasonic cleaning apparatus cannot be used to clean, for example, gas cookers, tables, desks, floors, walls, and automobiles, since these objects to be cleaned cannot be immersed in a cleaning liquid.

### SUMMARY OF THE INVENTION

An object of the present invention is to solve the above-mentioned problems in the conventional ultrasonic cleaning apparatus and to provide an ultrasonic cleaner that does not require prior immersion of an object to be cleaned in a cleaning liquid and can simplify cleaning work.

To achieve the above object, an ultrasonic cleaner according to the present invention comprises a body section; a vibration generator mounted in the body section and having a vibration-transmitting portion formed at its front end for transmitting vibration to an object to be cleaned; and a cleaning-medium feed section for feeding a cleaning medium to the object to be cleaned.

In this case, the vibration-transmitting portion is pressed against an object to be cleaned to thereby transmit vibration to the object to be cleaned, and a cleaning medium is fed to the object to be cleaned. Thus, vibration causes adhering dirt to be eluted into the cleaning medium from the object to be cleaned, thereby removing dirt from the object.

Therefore, the ultrasonic cleaner according to the present invention eliminates the need for prior immersion of an object to be cleaned in a cleaning medium, thereby simplifying work for cleaning an object to be cleaned.

Furthermore, in application to cleaning of objects other than clothing, the ultrasonic cleaner according to the present invention can be used to clean, for example, a gas cooker, table, desk, floor, wall, or automobile, while feeding a cleaning medium to the object to be cleaned.

Preferably, the vibration-transmitting portion is formed at a front end of a horn of the vibration generator; and a slide-smoothing surface is formed on a front end face of the horn.

Preferably, the cleaning-medium feed section is formed such that the front end of the horn faces the cleaning-medium feed section.

Preferably, the cleaning-medium feed section assumes the form of a slit.

Preferably, the cleaning-medium feed section is adapted to feed an object to be cleaned with a cleaning medium contained in a cleaning medium container.

Preferably, the cleaning medium container is removably attached to the body section.

Preferably, a tongue is provided adjacent to the front end of the horn; and when the tongue is pressed against an object to be cleaned, the front end of the horn is caused to protrude from the slit.

Preferably, protrusion of the front end of the horn from the slit is accompanied by discharge of the cleaning medium from the cleaning medium container.

Preferably, a brush is implanted adjacent to the vibration-transmitting portion.

In this case, brushing by the brush ensures removal of adhering dirt from an object to be cleaned.

Preferably, the ultrasonic cleaner according to the present invention further comprises a load detector for detecting load imposed on a vibrator of the vibration generator; and an oscillator circuit for generating vibration on the basis of a detected load.

### BRIEF DESCRIPTION OF THE DRAWINGS

The structure and features of the ultrasonic cleaner according to the present invention will be readily appreciated as the same becomes better understood by referring to the drawings, in which:

FIG. 1 is a sectional view of an ultrasonic cleaner according to a first embodiment of the present invention;

FIG. 2 is a perspective view of a horn in the first embodiment;

FIG. 3 is a diagram showing a control unit of the ultrasonic cleaner according to the first embodiment;

FIG. 4 is a sectional view of an ultrasonic cleaner according to a second embodiment of the present invention;

FIG. 5 is a front view of an ultrasonic cleaner according to a third embodiment of the present invention;

FIG. 6 is a perspective view of a nozzle attachment in the third embodiment; and

FIG. 7 is a schematic view showing a form of use of an ultrasonic cleaner according to a fourth embodiment of the present invention.

### DESCRIPTION OF THE PREFERRED EMBODIMENTS

Embodiments of the present invention will next be described in detail with reference to the drawings.

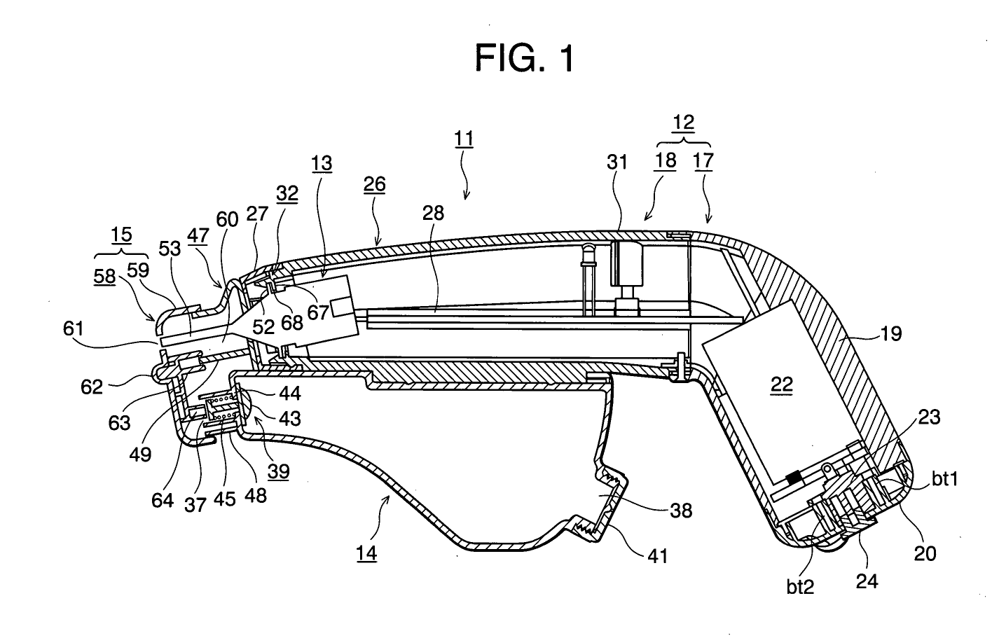

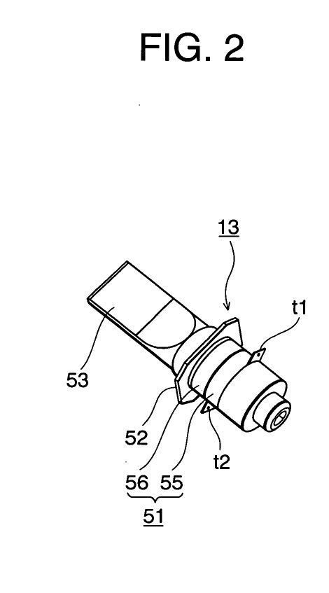

FIG. 1 is a sectional view of an ultrasonic cleaner according to a first embodiment of the present invention, and FIG. 2 is a perspective view of a horn in the first embodiment.

In FIGS. 1 and 2, an ultrasonic cleaner 11 includes a bent-shape body section 12; a vibration generator 13 mounted in a front end portion (a left-hand portion in FIG. 1) of the body section 12; a tank 14, which serves as a cleaning medium container removably attached to the body section 12 and adapted to contain an unillustrated cleaning medium such as water or a cleaning liquid; and a nozzle attachment 15 disposed at the front ends (left-hand ends in FIG. 1) of the body section 12 and the tank 14. The body section 12 includes a power unit accommodating section 17, which functions as a grip to hold when an operator is to hold the ultrasonic cleaner 11; and a control unit accommodating section 18 formed in such a manner as to be inclined at a predetermined angle, 60° in the present embodiment, with respect to the power unit accommodating section 17.

The power unit accommodating section 17 includes a battery box 19; a battery cap 20 removably attached to the battery box 19; a rechargeable battery 22, which serves as a power supply and is disposed in the battery box 19; a DC jack 23 connected to the battery 22 and attached to the battery cap 20 by use of bolts bt1 and bt2; and a cap 24 for covering the DC jack 23. The battery 22 is connected via the DC jack 23 to an unillustrated adapter for converting alternating current to direct current.

The control unit accommodating section 18 includes a control unit enclosure 26; a nozzle base 27 attached to the front end of the control unit enclosure 26; and a control board 28 accommodated in the control unit enclosure 26 and extending from the front side (left-hand side in FIG. 1) to the rear side (right-hand side in FIG. 1). A switch mechanism 31, which serves as an operation section, is provided on the surface of the control unit enclosure 26 at a predetermined position, and the switch mechanism 31 is connected to an unillustrated control unit mounted on the control board 28. The switch mechanism 31 includes an unillustrated power switch; a changeover switch for switching degrees of intensity of vibration; and an indicator adapted to indicate the condition of the ultrasonic cleaner 11 and including a lamp of light-emitting diode or the like. A horn attachment portion 32 is formed at the front end of the control unit enclosure 26; the vibration generator 13 is attached to the horn attachment portion 32; and terminals t1 and t2 of the vibration generator 13 are connected to the control unit.

The battery box 19, the battery cap 20, and the control unit enclosure 26 are formed of resin and partially constitute a case of the ultrasonic cleaner 11.

The vibration generator 13 includes a vibrator 51 composed of piezoelectric elements 55 and 56; a flange member 52 attached to the vibrator 51 at a node of vibration; and a metallic, hollow horn 53 formed in such a manner as to protrude frontward from the flange member 52. When voltage of a predetermined frequency and a predetermined amplitude is applied to the piezoelectric elements 55 and 56 via the terminals t1 and t2, ultrasonic vibration is generated at a frequency (50 kHz in the present embodiment) and an amplitude that are set by the vibrator 51. The horn 53 is formed such that the rear end (the right-hand end in FIG. 1) assumes a circular shape, the circular shape is flattened in the frontward direction, and the front end assumes the shape of a thin, flat beak. A flat portion of the horn 53 serves as a vibration-transmitting portion for transmitting vibration to an object to be cleaned.

The horn attachment portion 32 has an annular rest 67 extending radially inward. The vibration generator 13 is attached to the control unit accommodating section 18 such that the flange member 52 is pressed against the rest 67 via a seal member 68. In this state, the horn 53 is caused to protrude frontward through the nozzle base 27.

In the tank 14, a discharge port 37 through which a cleaning medium is discharged is formed at its front end, and a replenishment port 38 through which the tank 14 is replenished with the cleaning medium is formed at its rear end. An on-off valve 39 for selectively opening the discharge port 37 is disposed at the discharge port 37, and a tank cap 41 for opening/closing the replenishment port 38 is disposed on the replenishment port 38. The on-off valve 39 includes a valve body 43 and a spring 45, which serves as a biasing member for biasing the valve body 43 in such a manner as to press the valve body 43 against a valve seat 44. A guide member 47 is formed integral with the tank 14 at the front end of the tank 14. The guide member 47 supports the nozzle attachment 15 such that the nozzle attachment 15 is reciprocatively slidable. The guide member 47 includes a guide 48, which is annularly formed and surrounds the vibration generator 13 and the discharge port 37, and a rod-like guide 49 formed at the center of the guide member 47.

The nozzle attachment 15 includes a nozzle front 58 assuming a round shape, and an annular side wall 59 extending rearward from an outer, peripheral edge of the nozzle front 58. The side wall 59 slides on the guide 48. The nozzle attachment 15, the guide member 47, and the tank 14 define a closed space 60. The nozzle front 58 includes a slit 61, which is formed such that the front end of the horn 53 faces the slit 61 and which serves as a cleaning-medium feed section for feeding a cleaning medium to an object to be cleaned; a tongue 62, which is formed underneath and adjacent to the slit 61 and in parallel with the slit 61 in such a manner as to protrude frontward; a portion-to-be-guided 63, which is formed behind the nozzle attachment 15 in such a manner as to surround the guide 49; and an abutment portion 64, which is formed behind the nozzle attachment 15 in such a manner as to protrude toward the on-off valve 39.

In operation of the thus-configured ultrasonic cleaner 11, when an operator turns on a power switch through operation of the switch mechanism 31, the vibrator 51 generates ultrasonic vibration, which is transmitted through the horn 53 to the front end of the horn 53. When the operator holds the power unit accommodating section 17 and presses the tongue 62 against an object to be cleaned, the nozzle attachment 15 is caused to slightly retreat (move rightward in FIG. 1) while the side wall 59 and the portion-to-be-guided 63 slide along the guide 48 and the guide 49, respectively. As a result, the front end of the horn 53 protrudes frontward through the slit 61 and is pressed against the object to be cleaned, whereby vibration is transmitted to the object to be cleaned.

As the nozzle attachment 15 retreats, the abutment portion 64 presses the valve body 43 rearward; consequently, the valve body 43 moves away from the valve seat 44, whereby the discharge port 37 is opened. As a result, a cleaning medium contained in the tank 14 is discharged from the discharge port 37; enters the space 60; and is gradually discharged along the periphery of the horn 53 through the slit 61, thereby wetting the object to be cleaned.

As a result, vibration causes adhering dirt to be eluted into the cleaning medium from the object to be cleaned, thereby removing dirt from the object. Preferably, in order to reduce resistance of an object to be cleaned when the front end of the horn 53 is moved while being in press contact with the object and to prevent the front end of the horn 53 from scratching the object to be cleaned, the front end face of the horn 53 is curved or chamfered so as to be formed into a slide-smoothing surface.

As described above, in the present embodiment, vibration is transmitted to an object to be cleaned, and a cleaning medium is fed to the object to be cleaned, thereby eliminating the need for prior immersion of the object to be cleaned in the cleaning medium and thus simplifying work for cleaning the object to be cleaned.

Also, in application to cleaning of objects other than clothing, the ultrasonic cleaner of the present embodiment can be used to clean, for example, a gas cooker, table, desk, floor, wall, or automobile, while feeding a cleaning medium to the object to be cleaned.

Furthermore, since a cleaning medium is discharged along the horn 53, the cleaning medium can be concentrically fed to a portion of an object to be cleaned to which vibration is transmitted. Therefore, not only can cleaning efficiency be enhanced, but also the quantity of the cleaning medium to be fed can be reduced.

Next, a control unit of the ultrasonic cleaner 11 will be described.

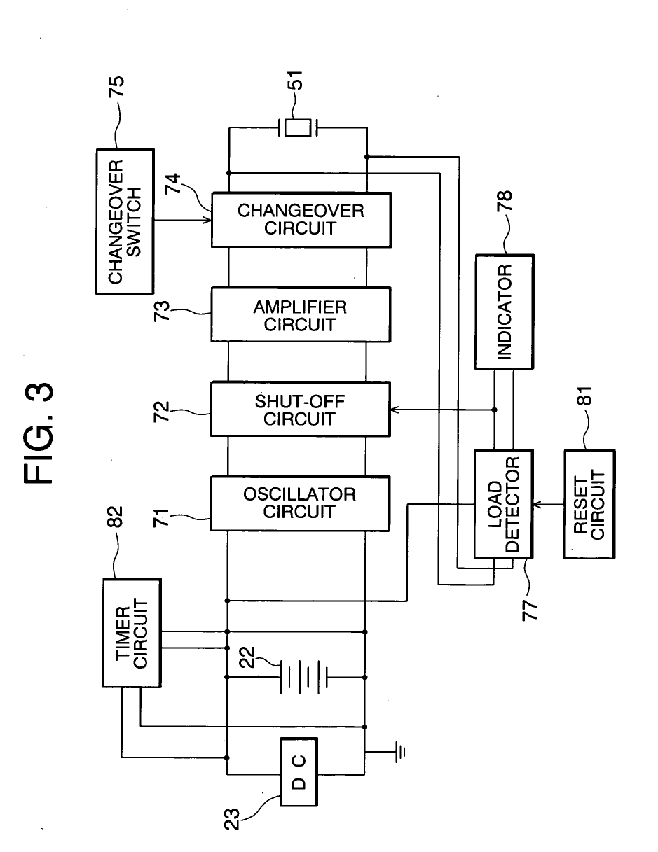

FIG. 3 is a diagram showing a control unit of the ultrasonic cleaner according to the first embodiment of the present invention.

In FIG. 3, reference numeral 22 denotes a battery; reference numeral 23 denotes a DC jack used to charge the battery 22; and reference numeral 71 denotes an oscillator circuit, to which voltage is applied from the battery 22 or from a commercial power supply via the DC jack 23 and which generates an oscillation signal. An oscillation signal generated by the oscillator circuit 71 is sent to an amplifier circuit 73 via a shut-off circuit 72. The amplifier circuit 73 amplifies the oscillation signal, thereby generating voltage of a predetermined frequency and a predetermined amplitude. The voltage is sent to a changeover circuit 74. The changeover circuit 74 changes the amplitude of the voltage as needed. Then, the voltage is applied to the terminals t1 and t2 (FIG. 2) of the vibrator 51. A changeover switch 75 provided in the switch mechanism 31 (FIG. 1) is connected to the changeover circuit 74. Pressing the changeover switch 75 changes voltage to be applied to the vibrator 51, whereby degrees of intensity of vibration can be switched through change of the amplitude of vibration.

Opposite ends of the vibrator 51 are connected to a load detector 77 for detecting load imposed on the vibrator 51, and voltage applied to the vibrator 51 is sent to the load detector 77. The load detector 77 detects variation in the frequency of voltage applied to the vibrator 51 through phase comparison. The detected variation in frequency is sent to the oscillator circuit 71 as a feedback output. Thus, feedback control is carried out on the basis of load imposed on the vibrator 51, whereby the vibrator 51 can generate vibration of a set frequency and a set amplitude. Notably, an indicator 78 of the switch mechanism 31 is connected to the load detector 77. When the ultrasonic cleaner 11 (FIG. 1) is normally driven, the load detector 77 causes a lamp of the indicator 78 to go on, thereby notifying an operator that the ultrasonic cleaner 11 is normally driven.

When, as a result of increase in load imposed on the vibrator 51, a detected variation in frequency exceeds a threshold valve, the load detector 77 generates a shut-off signal and sends the signal to the shut-off circuit 72. Upon reception of the signal, the shut-off circuit 72 shuts off the amplifier circuit 73 from the oscillator circuit 71 so as to prevent transmission of an oscillation signal to the amplifier circuit 73, thereby preventing generation of vibration. Also, the load detector 77 causes the lamp of the indicator 78 to go off, thereby notifying an operator that the ultrasonic cleaner 11 has stopped running.

Notably, reference numeral 81 denotes a reset circuit for resetting feedback control of the load detector 77 when the ultrasonic cleaner 11 is to be started, so as to facilitate start-up of the ultrasonic cleaner 11. Reference numeral 82 denotes a timer circuit for driving the ultrasonic cleaner 11 for a predetermined time when voltage is applied from a commercial power supply via the DC jack 23.

Next, a second embodiment of the present invention will be described. Structural features similar to those of the first embodiment are denoted by common reference numerals, and repeated description thereof is omitted. For the effect that the second embodiment yields through employment of structural features similar to those of the first embodiment, the effect that the first embodiment yields is applied accordingly.

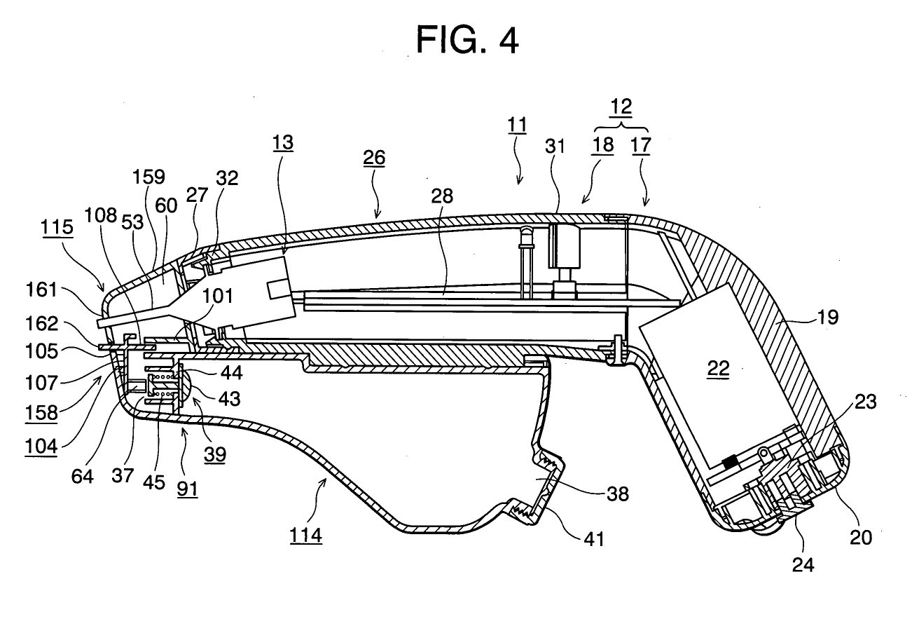

FIG. 4 is a sectional view of an ultrasonic cleaner according to the second embodiment.

In this case, an ultrasonic cleaner 11 includes a bent-shape body section 12; a vibration generator 13 mounted in a front end portion (a left-hand portion in FIG. 4) of the body section 12; and a tank-nozzle unit 91, which serves as a cleaning medium container-discharger removably attached to the body section 12 and adapted to contain an unillustrated cleaning medium and to discharge the cleaning medium along a horn 53 of the vibration generator 13. Notably, the front end (left-hand end in FIG. 4) of the horn 53 serves as a vibration-transmitting portion.

The tank-nozzle unit 91 includes a tank 114, which serves as a cleaning medium container for containing a cleaning medium; and a nozzle 115, which serves as a cleaning medium discharger formed integral with the tank 114 and adapted to discharge the cleaning medium.

In the tank 114, a discharge port 37 through which a cleaning medium is discharged, and a guide 101 are formed at its front end, and a replenishment port 38 through which the tank 114 is replenished with the cleaning medium is formed at its rear end (right-hand end in FIG. 4). An on-off valve 39 for selectively opening the discharge port 37 is disposed at the discharge port 37; an on-off valve operation unit 104 for operating the on-off valve 39 is disposed on the guide 101; and a tank cap 41 for opening/closing the replenishment port 38 is disposed on the replenishment port 38. The on-off valve 39 includes a valve body 43 and a spring 45, which serves as a biasing member for biasing the valve body 43 in such a manner as to press the valve body 43 against a valve seat 44.

The nozzle 115 includes a nozzle front 158 assuming a round shape, and an annular side wall 159 extending rearward from an outer, peripheral edge of the nozzle front 158. The nozzle 115 and the tank 114 define a closed space 60. The nozzle front 158 includes a first slit 161, which is formed so as to allow the front end of the horn 53 to protrude frontward (leftward in FIG. 4) and which serves as a cleaning-medium feed section for feeding a cleaning medium to an object to be cleaned; and a second slit 105, which is formed underneath and adjacent to the first slit 161 and in parallel with the first slit 161.

The on-off valve operation unit 104 is disposed within the space 60 in a reciprocatively movable condition (in a leftward and rightward movable condition in FIG. 4). The on-off valve operation unit 104 includes a base 107, which is disposed within the space 60 in a vertically extending condition; a tongue 162, which is formed in such a manner as to protrude frontward from the base 107 and pass through the second slit 105; a portion-to-be-guided 108, which is formed in such a manner as to protrude rearward (rightward in FIG. 4) from the base 107 and is guided by the guide 101; and an abutment portion 64, which is formed in such a manner as to protrude from the base 107 toward the on-off valve 39.

In operation of the thus-configured ultrasonic cleaner 11, when an operator turns on the power switch through operation of the switch mechanism 31, which serves as an operation section, the vibrator 51 generates ultrasonic vibration, which is transmitted through the horn 53 to the front end of the horn 53.

When the operator holds the power unit accommodating section 17 and presses the front end of the horn 53 against an object to be cleaned, vibration is transmitted via the horn 53 to the object to be cleaned. When the tongue 162 is pressed against the object to be cleaned, in association with press contact of the front end of the horn 53 with the object to be cleaned, the portion-to-be-guided 108 slides along the guide 101, and the on-off valve operation unit 104 slightly retreats (moves rightward in FIG. 4). As a result, the abutment portion 64 presses the valve body 43 rearward; consequently, the valve body 43 moves away from the valve seat 44, whereby the discharge port 37 is opened. As a result, a cleaning medium contained in the tank 114 is discharged from the discharge port 37; enters the space 60; and is gradually discharged along the periphery of the horn 53 through the first slit 161, thereby wetting the object to be cleaned.

As a result, vibration causes adhering dirt to be eluted into the cleaning medium from the object to be cleaned, thereby removing dirt from the object.

Next, a third embodiment of the present invention will be described. Structural features similar to those of the first embodiment are denoted by common reference numerals, and repeated description thereof is omitted. For the effect that the third embodiment yields through employment of structural features similar to those of the first embodiment, the effect that the first embodiment yields is applied accordingly.

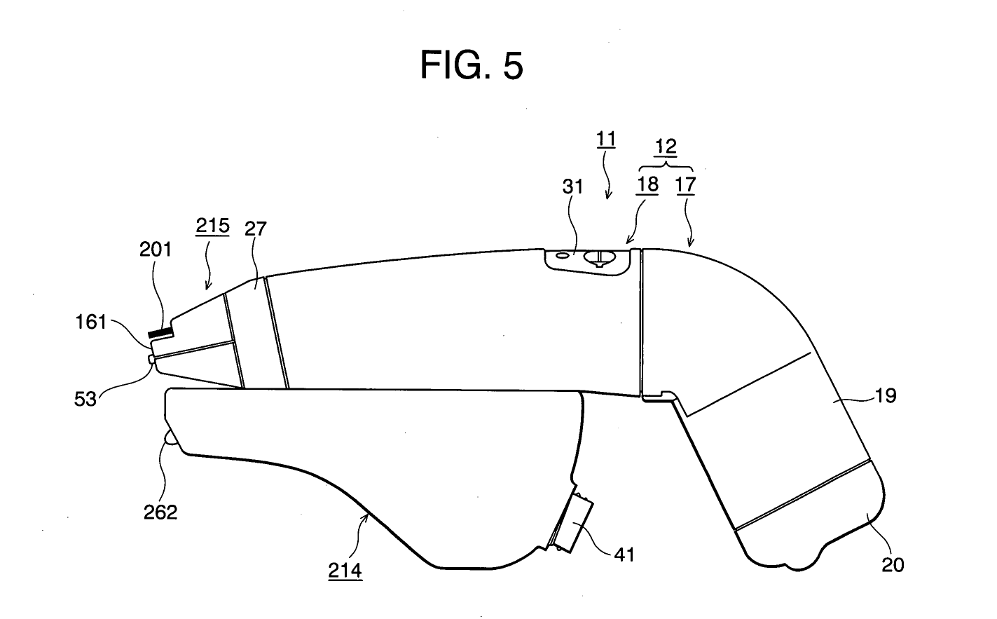

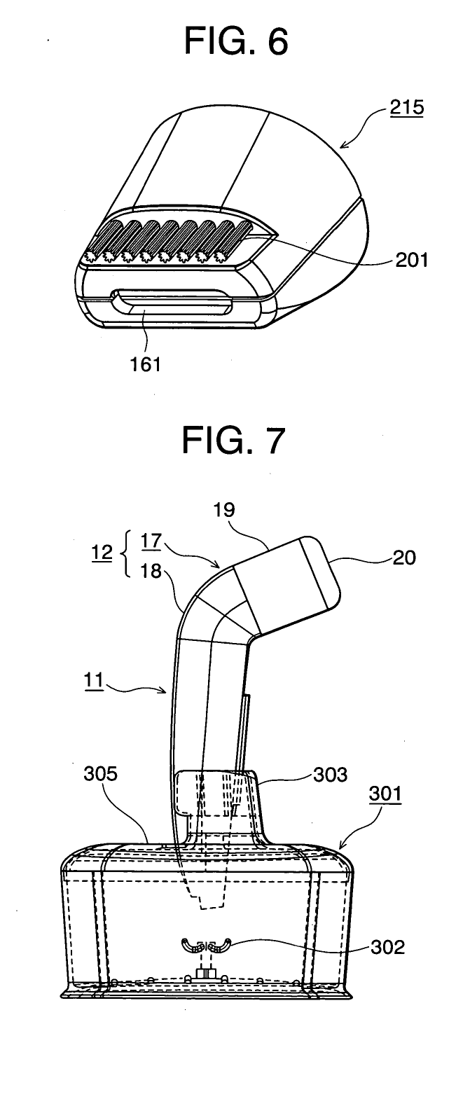

FIG. 5 is a front view of an ultrasonic cleaner according to the third embodiment. FIG. 6 is a perspective view of a nozzle attachment in the third embodiment.

In FIGS. 5 and 6, an ultrasonic cleaner 11 includes a bent-shape body section 12; a vibration generator 13 (FIG. 1) mounted in a front end portion (a left-hand portion in FIG. 5) of the body section 12; a tank 214, which serves as a cleaning medium container removably attached to the body section 12 and adapted to contain a cleaning medium; and a nozzle attachment 215 disposed at the front end (left-hand end in FIG. 5) of the body section 12.

A tongue 262 is disposed at the front end of the tank 214 in a reciprocatively movable condition (in a leftward and rightward movable condition in FIG. 5). As the tongue 262 is caused to retreat (move rightward in FIG. 5), the cleaning medium contained in the tank 214 is gradually discharged along the periphery of the tongue 262.

The nozzle attachment 215 is removably attached to the body section 12. In the nozzle attachment 215 attached to the body section 12, the front end of the horn 53 slightly protrudes from the first slit 161, which serves as a cleaning-medium feed section. Brushes 201 are implanted in the front end of the nozzle attachment 215 above the first slit 161 and adjacent to the front end of the horn 53 in a horizontally arrayed condition. Notably, the front end of the horn 53 serves as a vibration-transmitting portion.

In operation of the thus-configured ultrasonic cleaner 11, when an operator turns on the power switch through operation of the switch mechanism 31, which serves as an operation section, the vibrator 51 (FIG. 3) generates ultrasonic vibration, which is transmitted through the horn 53 to the front end of the horn 53.

When the operator holds the power unit accommodating section 17 and presses the front end of the horn 53 and the respective front ends of the brushes 201 against an object to be cleaned, vibration is transmitted from the horn 53 to the object to be cleaned. When the front end of the horn 53 is pressed against the object to be cleaned, the tongue 262 is pressed against the object to be cleaned and is caused to slightly retreat. As a result, a cleaning medium contained in the tank 214 is gradually discharged along the periphery of the tongue 262, thereby wetting the object to be cleaned. Alternatively, the cleaning medium contained in the tank 214 may be fed to the nozzle attachment 215, so that the cleaning medium is discharged along the brushes 201 to thereby be fed to the object to be cleaned.

As a result, vibration and brushing, which is effected by the brushes 201, cause adhering dirt to be eluted into the cleaning medium from the object to be cleaned, thereby removing dirt from the object.

Since not only ultrasonic vibration but also brushing effected by the brushes 201 can be utilized, adhering dirt can be reliably removed from the object to be cleaned.

Next, a fourth embodiment of the present invention will be described. Structural features similar to those of the first embodiment are denoted by common reference numerals, and repeated description thereof is omitted. For the effect that the fourth embodiment yields through employment of structural features similar to those of the first embodiment, the effect that the first embodiment yields is applied accordingly.

FIG. 7 is a schematic view showing a form of use of an ultrasonic cleaner according to the fourth embodiment.

In FIG. 7, reference numeral 301 denotes a cleaning container which has an opening portion 305 formed on its upper face and contains an unillustrated cleaning medium and in which an object 302 to be cleaned is set in place. A holding portion 303 is formed on the upper face of the cleaning container 301 in such a manner as to stand upward from the peripheral edge of the opening portion 305.

The ultrasonic cleaner 11 in such a condition that the tank 14 (FIG. 1) is removed from the body section 12 can be engaged with the cleaning container 301 through engagement of a front end portion (a lower end portion in FIG. 7) of the control unit accommodating section 18 with the holding portion 303.

In operation of the thus-configured ultrasonic cleaner 11, when an operator turns on the power switch through operation of the switch mechanism 31, which serves as an operation section, the vibrator 51 (FIG. 3) generates ultrasonic vibration, which is transmitted through the horn 53 to the front end (the lower end in FIG. 7) of the horn 53. Notably, the front end of the horn 53 serves as a vibration-transmitting portion.

When the operator engages the ultrasonic cleaner 11 with the cleaning container 301 to thereby immerse a front end portion of the control unit accommodating section 18 in a cleaning medium contained in the cleaning container 301, vibration is transmitted to the object 302 to be cleaned, via the horn 53 and the cleaning medium.

As a result, vibration causes adhering dirt to be eluted into the cleaning medium from the object 302 to be cleaned, thereby removing dirt from the object 302.

The present invention is not limited to the above-described embodiments. Numerous modifications and variations of the present invention are possible in light of the spirit of the present invention, and they are not excluded from the scope of the present invention.

What is claimed is:

1. An ultrasonic cleaner comprising:
(a) a body section;
(b) a vibration generator mounted in the body section and having a vibration-transmitting portion formed at its front end for transmitting vibration to an object to be cleaned; and
(c) a cleaning-medium feed section for feeding a cleaning medium to the object to be cleaned.

2. An ultrasonic cleaner according to claim 1, wherein:
(a) the vibration-transmitting portion is formed at a front end of a horn of the vibration generator; and
(b) a slide-smoothing surface is formed on a front end face of the horn.

3. An ultrasonic cleaner according to claim 2, wherein the cleaning-medium feed section is formed such that the front end of the horn faces the cleaning-medium feed section.

4. An ultrasonic cleaner according to claim 3, wherein the cleaning-medium feed section assumes the form of a slit.

5. An ultrasonic cleaner according to claim 1, wherein the cleaning-medium feed section is adapted to feed an object to be cleaned with a cleaning medium contained in a cleaning medium container.

6. An ultrasonic cleaner according to claim 5, wherein the cleaning medium container is removably attached to the body section.

7. An ultrasonic cleaner according to claim 4, wherein:
(a) a tongue is provided adjacent to the front end of the horn; and
(b) when the tongue is pressed against an object to be cleaned, the front end of the horn is caused to protrude from the slit.

8. An ultrasonic cleaner according to claim 7, wherein protrusion of the front end of the horn from the slit is accompanied by discharge of the cleaning medium from the cleaning medium container.

9. An ultrasonic cleaner according to claim 1, wherein a brush is implanted adjacent to the vibration-transmitting portion.

10. An ultrasonic cleaner according to claim 1, further comprising:
(a) a load detector for detecting load imposed on a vibrator of the vibration generator; and
(b) an oscillator circuit for generating vibration on the basis of a detected load.
